(19) United States
(12) Patent Application Publication
(10) Pub. No.: US 2026/0293835 A1
(43) Pub. Date: Oct. 1, 2026

(54) A CUBICLE AND A STABLE

(71) Applicant: R. Andringa Holding B.V., Jistrum (NL)

(72) Inventor: Rinse ANDRINGA, Jistrum (NL)

(73) Assignee: R. Andringa Holding B.V., Jistrum (NL)

(21) Appl. No.: 18/996,380

(22) PCT Filed: Jul. 17, 2023
(86) PCT No.: PCT/NL2023/050382

§ 371 Date: Jan. 17, 2025

(30) Foreign Application Priority Data
Jul. 18, 2022 (NL) 2032522

(51) Int. Cl. A01K 1/00

(52) U.S. Cl. CPC A01K 1/0011

(57) ABSTRACT

Cubicle for a cow, provided with two floating limiters extending along a substantially horizontal plane to delimit a cow walk-in area, wherein a cow lying area (S) is available under the two limiters, wherein at least at an entrance of the cubicle a mutual distance (L) between the limiters is 105 cm at a maximum. Further, an aspect concerns a cubicle for a cow, provided with two substantially horizontal floating limiters to delimit a cow walk-in area, wherein a cow lying area is available under the two limiters, wherein a walk-through barrier is provided at a proximal part of the limiters, wherein the walk-through barrier is configured to define a central free space (W). The invention further provides a stable provided with at least one row of cubicles, which row of cubicles extends along a respective cow walk-through path, wherein at least a number of the cubicles of the row comprise a cubicle according to the invention.

The invention concerns a cubicle for a cow.

Cubicles for cows are generally known. In cattle farming, normally, use is made of loose houses with dunging passages and lying boxes for keeping cattle. A lying box is a more or less screened-off space (‘cubicle’) where a cow can lie down to ruminate and rest, without being disturbed by other cows loafing in the stable. For milk production it is important that a cow passes a large part of the day (about 10-14 hours a day) lying down. Further, it is important that the lying surface remains free of excrements, so that the cow does not get soiled with excrements and, in particular, the udders remain clean.

Such lying boxes generally have a rectangular lying surface, tailored to the minimum dimensions that a cow needs to be able to lie and stand. The cow enters and exits the lying box via an entrance at a rear end of the lying box proximal to the dunging passage. The bottom of the lying box is generally raised with respect to the dunging passage running along the rear ends of the lying boxes, which dunging passage may be equipped with provisions for carrying off excrements. The bottom may be formed by, for example, hard material, a covering from soft material, for example a cow mattress, or loose litter such as sawdust or straw.

Conventional cubicles comprise fences along the two long sides of the lying box, which fences, on the one hand, screen off the space, for instance from adjacent lying boxes or from other cows, and further serve to counteract the cow rising or lying down crosswise or obliquely in the lying box, in consequence of which, upon defecation, the bottom of the lying box would get soiled.

The cows occupying the lying boxes should, in a length direction, on the one hand, preferably stand or lie forwards so far that also the hind legs stand or rest on the bottom of the lying box. On the other hand, the cows should not stand forwards so far that the dung, upon excretion, ends up on the bottom of the lying box.

To this end, the conventional lying boxes are provided with a continuous shoulder beam at a height above the floor of the lying box, which is positioned such that the freedom of forward movement of the cow is limited in that the shoulders of the cow contact the shoulder beam when the cow attempts to walk forwards in the lying box too far. Furthermore, lying boxes are sometimes each equipped with a further limiting device on the bottom, to prevent the cows, once they are lying, from moving forwards too far. Shoulder beams, however, have various drawbacks, as is explained in more detail in NL1033422.

The vertical fences of the known cubicles provide relatively little comfort. A possible solution to this problem is described in EP1579760B1, in which it is proposed to apply floating bent profiles. The bent profiles are set up in an upwardly pivotable manner. The bent profiles comprise bend parts, such that ends of the profiles are next to each other and thus form a central walk-through obstacle (as a shoulder beam), while entrance parts of the profiles are relatively far removed from each other. Seen in top plan view, the profiles follow the contours of the animal. A free space extending between the profiles is therefore strongly variable. During use, a cow can take up position under the profiles. A drawback of this known configuration is that there is a relatively high chance, in practice, that a cow does not reach a desired lying position but (seen in top plan view) takes up an oblique position, as a result of which the cow is partly outside a rest area available to the cow, for instance within a lying area of an adjacent cubicle. In such a case, moreover, there is a high chance that dung ends up in the lying area of the cows instead of behind the lying box. Further, it is a drawback that the cow, when moving from the standing position to the lying position, and vice versa from lying position to standing position, is hindered by the profiles, at least at a head part of the animal.

The present invention contemplates the provision of an improved cubicle for a cow. In particular, the invention contemplates the provision of a cubicle that is extra comfortable for the cow, while the cubicle, in addition, can bring about a desired lying position of the cow (such that the cow takes up a position in the cubicle correctly, that is, in a straight position rather than obliquely).

According to a first aspect of the invention, to this end, a cubicle is provided that is characterized by the features of claim 1.

The cubicle for a cow is preferably provided with two substantially horizontal floating (i.e., extending along a substantially horizontal plane) limiters to delimit a cow walk-in area, wherein a cow lying area is available under the two limiters, wherein at least at an entrance of the cubicle a mutual distance between the limiters amounts to 105 cm at a maximum.

Surprisingly, a cubicle that is provided with these features, having a relatively narrow entrance (i.e., an entrance having a width of 105 cm at a maximum) in combination with use of the floating limiters mentioned (which define the entrance mentioned), has been found to provide not only a particularly comfortable cubicle, but also a cubicle where the cow will take up a position in the box straightly. Without wishing to be bound by any theory, it is noted that a cow wishing to enter the cubicle (generally from a dunging passage) will have to “park” into the cubicle straightly as a result of the narrow entrance that is available between the floating limiters. The cow will enter the cubicle and walk parallel to the limiters, from the entrance in the direction of an opposite cubicle end (in particular, up to a walk-through limiter of the cubicle), in order then to reposition itself from standing position to lying position. A repositioning of a cow usually involves fixed movement patterns, comprising kneeling, bending, and stretching movements, such that a length direction of the cow remains substantially unchanged during that displacement. Since the cow in the standing position is already standing parallel to the floating limiters due to parking-in straightly, it will likewise, in the lying position, be lying straightly, and centrally, in the length direction of the cubicle. It is noted here that a bottom surface covered by the cow, when seen in top plan view (‘footprint’), is much greater in the lying position than in the standing position. By use of the two floating limiters, the cow, in the lying position, can extend comfortably under the two floating limiters. Further, it has been found that in this manner relatively wide lying boxes can be defined in a stable or like resting environment, yielding an extra boost of comfort for the cows.

Preferably, opposite parts of the two limiters are provided not with bend parts, but with parallel straight limiter parts which extend, in particular, throughout the length of the limiters, at an above-mentioned mutual distance from each other of 105 cm at a maximum, so as to provide a desired straight parking/guiding for the cow. Indeed, it has been found in practice, in particular, that the opposite (elongate, straight) parts of the two limiters, seen in top plan view, should not follow the contour of a cow. Further, it has been found advantageous to configure the limiters such that a width of a free space extending between the limiters (seen in top plan view) is substantially constant.

According to an extra advantageous aspect, a width of a cow lying area which is under the two limiters (in particular, of the cubicle lying surface) can be greater than 130 cm and amount to, for instance, circa 150 cm, for example a width in the range of 140-160 cm or 130-170 cm. In this manner, a particularly comfortable lying area for the cow can be furnished.

According to a further elaboration, the two limiters can be provided with substantially parallel, mutually facing cow guide edges, wherein the guide edges extend in particular over a distance of at least 50 cm (e.g., at least 100 cm) parallel to each other from the entrance of the cubicle, and are at the mentioned mutual distance of 105 cm at a maximum, measured in a direction at right angles to a longitudinal direction of the guide edges.

In this manner, ‘parking-in’ of a cow can be guided over a relatively long distance so as to increase the chances that the cow enters the cubicle straightly (i.e., parallel to a central axis of the cubicle), then to settle down straightly into a desired central and straight lying position.

Extra good results are achieved if the mutual distance between the limiters amounts to 95 cm at a maximum at the entrance of the cubicle and preferably 90 cm at a maximum (in other words: preferably, distal ends of the limiters are at the above-mentioned, relatively short, distance of 95 cm at a maximum and preferably 90 cm at a maximum, for example 85 cm at a maximum).

The limiters can each be implemented in different manners. According to a further implementation, one or each limiter can be part of a respective, substantially horizontally extending U-shaped profile, which can offer a relatively simple, durable and forceful configuration. Alternatively or additionally, each limiter can for instance comprise a (substantially horizontal) elongate straight profile or profile part, preferably having a length of at least 50 cm, in particular at least 100 cm, for example a length in the range of 120-200 cm, which leads to good results.

Further, it is advantageous if the cubicle is provided with a frame to couple a limiter to a ground behind a cubicle end remote from the cubicle entry (i.e., at a proximal cubicle area). To the skilled person it will be clear that such a (supporting) frame can be implemented in different manners, and may for instance consist of one or several frame parts, can comprise different frame bend pieces, and that a limiter may be attached to that frame in different manners. The frame can for instance comprise a tube frame. Further, the frame may for instance be partly or wholly integrated with one or more limiters or be manufactured in one piece therewith.

According to a further elaboration, limiters of neighboring cubicles may be coupled to each other and/or be manufactured in one piece, for instance by forming part of and/or being formed by a U-shaped profile. In this manner, an extra stable and durable construction can be achieved. Preferably, the U-shaped profile is relatively wide (measured in a direction at right angles to the longitudinal legs), for example wider than 25 cm, in particular wider than 40 cm.

According to a second aspect of the invention, which can be combined with the first aspect described hereinabove, a cubicle for a cow is provided with two substantially horizontal floating (i.e., extending along a substantially horizontal plane) limiters to delimit a cow walk-in area, with a cow lying area being available under the two limiters, while a walk-through barrier is provided at a proximal part of the limiters, wherein the walk-through barrier is configured to define a central free space.

In this manner, extra comfort can be offered, whereby a cow that walks into the cubicle can reach the walk-through barrier and, for instance, can stick its head into the central free space furnished by that barrier. Shoulders of the cow can for instance touch the walk-through barrier, which can be the signal for the cow to reposition from standing position to a lying position. The central position of the free space of the walk-through barrier can cause the cow to move so as to park straightly in the cubicle. A combination of this second aspect of the invention with the above-described first aspect can furnish a most favorable cubicle configuration. A width of the free space that is furnished by the walk-through barrier is preferably greater than 15 cm, for example at least 20 cm, for example a width in the range of 25-40 cm, or 25-50 cm, which yields good results.

The walk-through barrier, according to a further elaboration, preferably comprises two mutually spaced apart, floating barrier elements (between which the central free space mentioned is available). A distance between the two floating barrier elements is preferably greater than 15 cm, in particular greater than 20 cm, and is for instance in the range of 15-40 cm, in particular 25-40 cm, or 25-50 cm. Furthermore, it may be advantageous when each of the two floating barrier elements is at a higher level than a height of the two floating limiters of the cubicle. The barrier elements can be implemented in different manners, but are preferably provided with rounded or substantially round, mutually facing outer surfaces. To this end, preferably at least partly spheroidal (for example, spherical) barrier elements are used. In addition, it is advantageous if each of the floating barrier elements, from a first position, is upwardly displaceable (for instance relative to the floating limiters), preferably against a spring force and/or gravity. Both floating barrier elements may for instance be pivotable from the first position away from each other. In this manner, the barrier elements can move upwards and/or pivot apart during rising of the cow, to make rising easier.

In addition, the invention provides a stable provided with at least one row of cubicles, which row of cubicles extends along a respective cow walk-through path, wherein at least a number of the cubicles of the row comprise a cubicle according to the invention.

In this manner, the above-mentioned advantages can be achieved, whereby a number of cows can make use of the stable in a very comfortable way and in a particularly hygienic way.

The invention will now be further elucidated on the basis of an exemplary embodiment which is shown in the drawings.

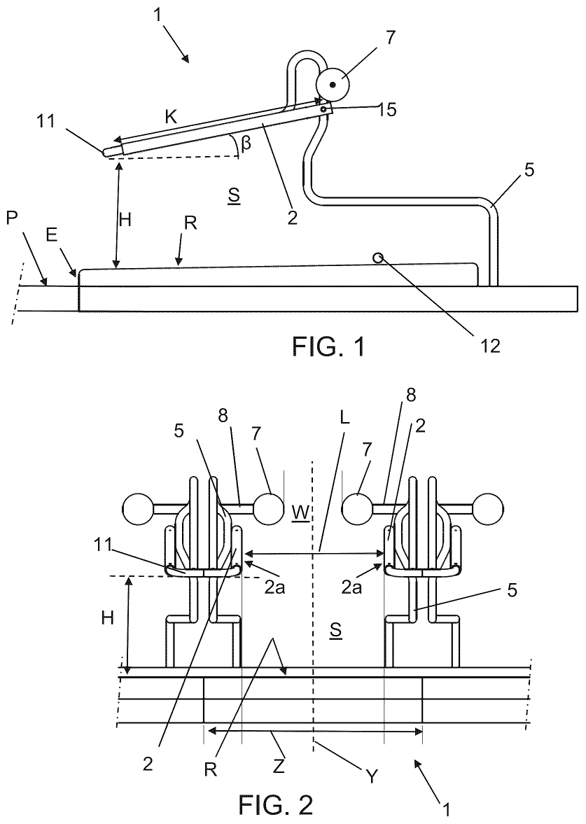

FIG. 1 shows a side view of a non-limiting exemplary embodiment of the invention;

FIG. 2 shows a rear view of the example shown in FIG. 1;

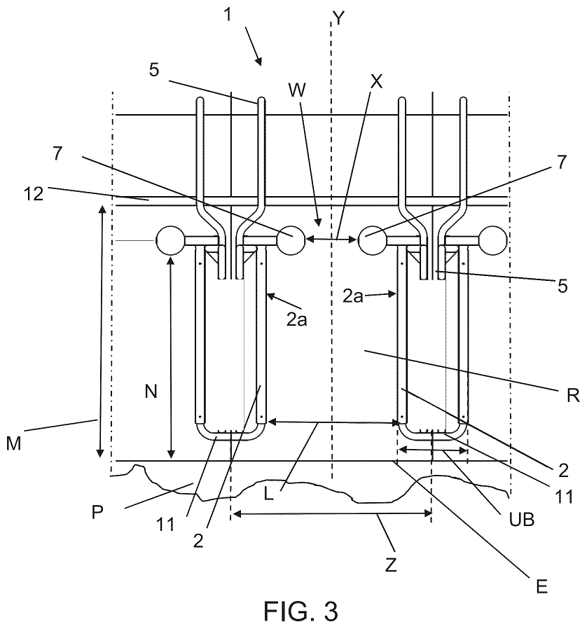

FIG. 3 shows a top plan view of the example shown in FIG. 1;

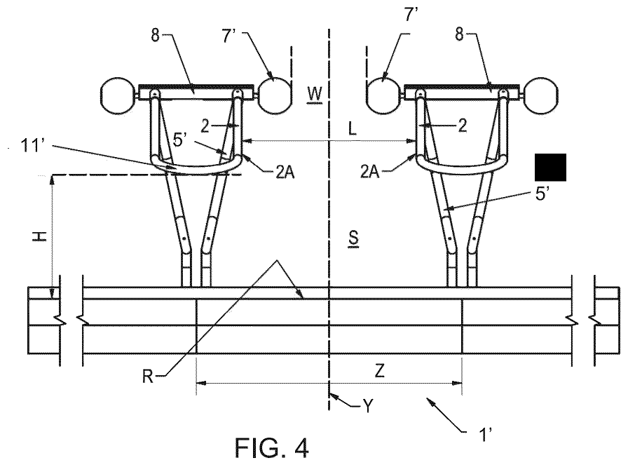

FIG. 4 shows a rear view, similar to FIG. 2, of an alternative exemplary embodiment of the invention; and

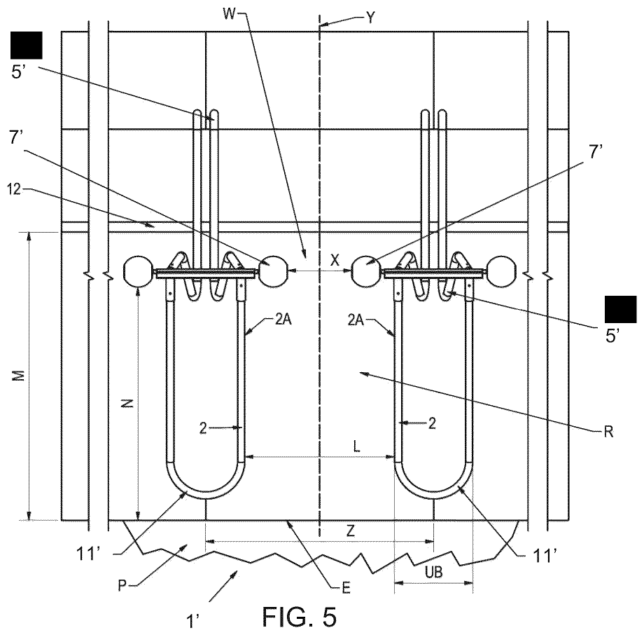

FIG. 5 shows a top plan view, similar to FIG. 3, of the alternative example shown in FIG. 4.

Like or corresponding features are designated in this patent application with like or corresponding reference signs.

The drawings (FIGS. 1-3) show schematically a cubicle 1 for a cow. The cubicle 1 can be part of a row of such cubicles, and, for instance, be in a stable. The cubicle 1 or respective row of cubicles can extend along a respective cow walk-through path P (with a cubicle longitudinal direction at right angles to a longitudinal direction of the path P), from which path P a cow can enter the cubicle 1 during use.

The cubicle 1 comprises, for instance, a bottom which furnishes a cow lying surface R, for instance a substantially rectangular lying surface R (having a width Z and a depth/length M). As mentioned, such a surface R may for instance be raised with respect to the path (or dunging passage) P running along an entrance of the cubicle 1. The bottom may be formed by, for example, hard material, a covering from soft material, for example, a cow mattress, or loose litter such as sawdust or straw, and/or the like.

Optionally, there may be provided a proximal delimitation of a lying surface furnished by the cubicle 1, which delimitation may be furnished by, for example, a horizontal girder, cross limiter and/or rod 12 which extends on or just above the bottom along the lying surface R (in a direction at right angles to a longitudinal direction of the cubicle 1, i.e., parallel to the path P). A depth M of the cubicle 1, at least, of an available lying surface R (measured between a cubicle entrance and the proximal limiter 12), can amount to, for example, at least circa 150 cm, for example, a depth M in the range of circa 170-220 cm. The entrance of the cubicle is in particular at a longitudinal edge E of the adjacent path P.

Advantageously, the cubicle 1 is provided with two floating (elongate) limiters 2 extending along a substantially horizontal plane (i.e., each limiter 2 extends substantially horizontally) to delimit a cow walk-in area. In this regard, substantially horizontal is understood to mean a horizontal plane, or a plane that includes an angle β of circa 25 degrees at a maximum with a horizontal plane (see FIG. 1), in particular an angle β of 15 degrees at a maximum (for example, circa 11 degrees). Each floating limiter 2 may for instance extend slightly upwardly inclined seen from a distal limiter end in the direction of an opposite (proximal) cubicle end (i.e., in the direction of the supporting frame 5). The two limiters 2 are preferably at an equal distance from a central, vertical, longitudinal median plane Y of the cubicle 1 (i.e., are positioned mirror-symmetrically with respect to that plane). Distal ends of the limiters 2 are at or near the entrance of the cubicle,

A relatively ample cow lying area S is available above the lying surface R and under the two floating limiters 2 (i.e., both limiters extend above the lying area S, and wholly remotely from the lying surface R). To this end, the two limiters 2 are each preferably at a height H of at least 50 cm above the cow lying surface R of the cubicle 1, in particular at or near a cow shoulder height, or slightly below a cow shoulder height. The floating limiters 2 therefore do not touch the bottom as such. The height H may for instance be in the range of circa 50-80 cm.

A width Z of a cow lying area under the two floating limiters 2 (i.e., of a respective lying surface R) is preferably greater than 130 cm and amounts to, for instance, circa 150 cm, for example a width in the range of 140-160 cm.

A width L of a free space extending between the limiters 2 is preferably substantially constant (seen in top plan view). In this manner, a substantially straight parking direction/guidance can be provided to the cow during use. Each floating guide/limiter 2 can for instance have a length K of at least 50 cm, in particular at least 100 cm, and preferably extends in a straight line (in particular parallel to a longitudinal direction and the longitudinal median plane Y of the cubicle 1, and for instance at right angles to an above-mentioned proximal limiter 12 if present). Each limiter 2 can for instance comprise an elongate straight profile or profile part, preferably having a length of at least 50 cm (e.g., at least 100 cm), for example a length K in the range of 120-200 cm, more in particular 120-180 cm. According to a further elaboration, the two floating limiters 2 are provided with substantially parallel, mutually facing cow guide edges 2a, the guide edges 2a extending in particular over a distance of at least 50 cm (preferably at least 100 cm) parallel to each other from the entrance of the cubicle (i.e., from the distal limiter ends).

According to a further elaboration, two neighboring floating limiters 2 of two adjacent cubicles 1 may be integrated with each other, for instance by forming part of the same profile or the like (see FIGS. 2 and 3), and preferably by forming part of a U-shaped profile (in which case the elongate legs of the U-shaped profile furnish the two limiters 2). In this manner, a solid, floating construction can be achieved.

As follows from the drawing, each U-shaped profile has in particular two elongate substantially horizontal straight legs (viz., two limiters 2 as mentioned) and a horizontal (straight) cross leg 11. The horizontal cross leg 11, which extends at right angles to the two longitudinal legs 2 of the respective U-shaped profile, is at the entrance of the cubicle, and extends, for instance, parallel with respect to the longitudinal path P. In the depicted, slightly inclined position of the U-shaped profiles, each horizontal cross leg 11 is at a lowest position of the respective U-shaped profile.

Preferably, each U-shaped profile 2, 11 has a width UB, measured at right angles to respective parallel legs 2, which is in the range of circa 25-85 cm, for instance 25-75 cm, in particular 40-60 cm, for example a width of circa 50 cm. In this manner, a relatively ample (and wide), comfortable lying surface under the U-shaped profiles can be achieved, in combination with good cow guidance during cubicle entry. Since a length of the cross leg 11 determines the width UB of the U-shaped profile, the length of the cross leg 11 is preferably in the range of circa 25-75 cm, in particular 40-60 cm, where that length can amount to, for example, circa 50 cm.

With great advantage, at least at the entrance of the cubicle 1, a mutual distance L between the limiters 2 (and, for instance, between the cross legs 11 of respective U-shaped profiles) is 105 cm at a maximum (i.e., distal ends of the limiters 2 extend at this relatively short distance from each other). With such a relatively narrow entry space furnished by the limiters, it has been found that the chance is relatively high that a cow parks straightly during the entry of the cubicle 1, to be able then to take up a straight lying position. The mutual distance L between the limiters 2 can amount to, for example, 95 cm at a maximum (at least, at the entrance of the cubicle) and preferably 90 cm at a maximum. In the use of straight limiters 2, this mutual distance moreover remains preferably constant, viewed in a longitudinal direction of the limiters 2.

At a proximal cubicle part, a supporting frame 5 may be provided to couple a limiter 2 to a ground, behind a cubicle end remote from the cubicle entrance. In particular, the frame 5 may be implemented to keep the limiter 2 in the respective floating position, opposite the lying surface R. As mentioned, such a frame may be configured in different ways.

Optionally, each of the floating limiters 2 may be pivotable from the depicted (first, substantially horizontal) use position to a second substantially higher (nonhorizontal) position and vice versa, to offer space to a cow during rising. To this end, the limiter 2 may for instance be hingeably coupled to the frame 5, while a respective hinge coupling 15 is arranged to furnish the desired freedom of movement of the limiter 2. A hinge axis furnished by the hinge coupling 15 can for instance extend horizontally and at right angles to a longitudinal direction of the floating limiter 2. A stop or supporting means may be provided (for instance be integrated with the hinge coupling) to hinder downward displacement of a limiter 2 that is in the first position. The floating elongate limiter 2, when in the above-mentioned second position, can for instance include an angle greater than 25 degrees with a horizontal plane. Alternatively, the floating limiters 2 may be coupled to the frame 5 relatively rigidly. Further, the floating limiters 2 may for instance be manufactured from slightly flexible resilient material (to be able to bend along under the influence of a force exerted on the limiter by a cubicle user),

Alternatively, for instance, a part of such a supporting frame can extend along the limiter, above the lying surface, with the limiter being pivotably coupled to that supporting frame part by a number of pivoting arms (to pivot upwards from an above-mentioned first position to a second position). In that case, a pivot axis of the floating limiter may be parallel to a longitudinal direction of that limiter.

Preferably, the cubicle 1 is provided with a walk-through barrier at a proximal part of the cubicle 1. This walk-through barrier is preferably used in combination with the above-mentioned floating limiters 2, but may also be provided in a cubicle that is not provided with such floating limiters.

The present walk-through barrier is configured to define a central free space W (at a proximal part of the cubicle), having a width drawn in with arrow X (FIG. 3). This space W offers the cow extra parking-in guidance during the entry of the cubicle, whereby the cow can stick its head through that central free space W and, doing so, walk up (by shoulder) against the walk-through barrier. To that end, the walk-through barrier can comprise two mutually spaced-apart, preferably at least partly or wholly spheroidal, floating barrier elements 7 (between which the central free space W is available). The two barrier elements 7 are preferably at equal distances from a central vertical longitudinal median plane Y of the cubicle 1 (i.e., are set up mirror-symmetrically with respect to that plane Y).

Good results are achieved when a distance X between the two floating barrier elements 7 is greater than 15 cm, for instance a distance X in the range of 15-40 cm. Each of the two floating barrier elements 7 is preferably at a higher level than a height of the two floating limiters 2 (if present). Further, it is advantageous when each of the floating barrier elements 7 is upwardly displaceable from the depicted initial position (i.e., a first position), preferably against a spring force and/or gravity, so as to make rising easier for the cow. Both floating barrier elements 7 may for instance be arranged so as to be pivotable from the first position, away from each other, to a second position (and vice versa). The two floating barrier elements 7 may for instance be coupled to an above-mentioned supporting frame 5 by arms (whether pivotable or not so), and be held in a desired floating position above the lying surface R (in particular at or near a cow shoulder height). A distance N between the walk-through barrier 7, in particular each barrier element 7, and an entrance of the cubicle, seen in top plan view, is for instance in the range of 120-200 cm, in particular a range of 135-170 cm.

During use of the present exemplary embodiment, a cow can enter the cubicle 1 from the longitudinal path P. Doing so, the cow will move into the cubicle 1 straightly as a result of the particularly narrow entrance (furnished by the two limiters 2), and then reach the walk-through barrier 7 and bring its head straightly (forwards) between or along the two floating barrier elements 7. In practice, the chance thus appears to be particularly high that the cow extends completely parallel, centrally, along the longitudinal median plane Y. When the cow thereupon takes up a lying position (and, doing so, goes through customary repositioning steps), the cow will also reach a central lying position, straight, on the available lying surface R. An unwanted oblique position can thus be avoided, yielding attendant advantages. The cow's rising at a later stage can be made easier by use of floating parts (i.e., limiters 2 and barrier elements 7) that are capable of yielding upwardly a bit and/or moving along with the cow, as described hereinabove. In practice, it has been found that the present cubicle affords the cow the possibility to assume natural body postures (both standing and lying) while soiling of the lying box can be properly avoided.

FIGS. 4, 5 show an alternative exemplary embodiment, of a cubicle 1′, which differs from the example described hereinbefore in that each substantially horizontal U-shaped profile comprises two straight elongate legs 2 and a bent cross leg 11′, for example a cross leg 11′ that extends along a virtual circle (circular arc). In this manner, an extra strong and comfortable configuration can be achieved. Further, the alternative is provided with an adapted supporting frame 5′ (with lower frame parts arranged relatively close to each other, coupled to a floor of the stable).

In addition, the floating barrier elements 7′ of the alternative exemplary embodiment are each at or near the vertical level of the two floating limiters 2, for instance at the same height as proximal limiter parts.

It will be clear to the skilled person that the invention is not limited to the above-described exemplary embodiments. Various changes are possible within the scope of the invention as defined in the appended claims.

1. A cubicle for a cow, provided with two substantially horizontal floating limiters to delimit a cow walk-in area, wherein a cow lying area (S) is available under the two limiters, wherein at least at an entrance of the cubicle a mutual distance (L) between the limiters amounts to 105 cm at a maximum.

2. A cubicle according to claim 1, wherein at least one of said substantially horizontal limiters forms part of a substantially horizontally extending U-shaped profile, and in particular forms an elongate leg of the U-shaped profile, wherein the U-shaped profile preferably has a width (UB), measured at right angles to respective parallel legs, which is in the range of circa 25-85 cm, in particular 40-60 cm, for example a width (UB) of circa 50 cm.

3. A cubicle according to claim 1, wherein a width of a free space extending between the two substantially horizontal limiters is substantially constant.

4. A cubicle according to claim 1, wherein the two substantially horizontal limiters each extend at a height (H) of at least 50 cm above a lying surface of the cubicle, for example a height (H) in the range of circa 50-80 cm.

5. A cubicle according to claim 1, wherein a width (Z) of a cow lying area which is under the two substantially horizontal limiters is greater than 130 cm and amounts to, for instance, circa 150 cm, for example a width in the range of 140-160 cm.

6. A cubicle according to claim 1, wherein the two substantially horizontal limiters are provided with substantially parallel, mutually facing cow guide edges, wherein the guide edges in particular extend parallel to each other over a distance of at least 50 cm, from the entrance of the cubicle and are at said mutual distance of 105 cm at a maximum measured in a direction at right angles to a longitudinal direction of the guide edges.

7. A cubicle according to claim 1, wherein the mutual distance (L) between the limiters amounts to 100 cm at a maximum at the entrance of the cubicle and preferably 95 cm at a maximum, in particular 90 cm at a maximum.

8. A cubicle according to claim 1, wherein each limiter comprises a substantially horizontal elongate straight profile or profile part, preferably having a length of at least 50 cm, in particular 100 cm, for example a length in the range of 120-200 cm.

9. A cubicle according to claim 1, provided with a frame to couple a substantially horizontal limiter to a ground behind a cubicle end remote from the cubicle entrance.

10. A cubicle according to claim 1, wherein a walk-through barrier is provided at a proximal part of the limiters, wherein the walk-through barrier is configured to define a central free space.

11. A cubicle according to claim 10, wherein the walk-through barrier comprises two mutually spaced apart, preferably at least partly spheroidal, floating barrier elements, wherein a distance between the two floating barrier elements is preferably greater than 15 cm, in particular greater than 20 cm, and is for example in the range of 15-40 cm, in particular 25-40 cm or 25-50 cm, wherein each of the two floating barrier elements is preferably at a higher level than a height of the two floating limiters of the cubicle.

12. A cubicle according to claim 11, wherein each of the floating barrier elements is, from a first position, upwardly displaceable, for example relative to the limiters, preferably against a spring force and/or gravity, wherein both floating barrier elements are preferably pivotable from the first position away from each other.

13. A cubicle according to claim 1, wherein each of the limiters is pivotable from a first position to a second position.

14. A cubicle according to claim 1, wherein each substantially horizontal limiter includes an angle β of circa 25 degrees at a maximum with a horizontal plane, in particular an angle β of 15 degrees at a maximum, for example circa 11 degrees, at least, in an initial use position of the limiter.

15. A cubicle for a cow, for example a cubicle according claim 1, provided with two substantially horizontal floating limiters to delimit a cow walk-in area, wherein a cow lying area is available under the two limiters, wherein a walk-through barrier is provided at a proximal part of the limiters, wherein the walk-through barrier is configured to define a central free space.

16. A cubicle for a cow, provided with two, substantially horizontal floating limiters to delimit a cow walk-in area, wherein a cow lying area (S) is available under the two limiters, wherein at least at an entrance of the cubicle a mutual distance (L) between the limiters amounts to 105 cm at a maximum;
wherein each substantially horizontal limiter comprises an elongate straight profile or profile part, having a length of at least 100 cm, and is preferably part of a substantially horizontal U-shaped profile.

17. A cubicle for a cow, provided with two floating limiters to delimit a cow walk-in area, wherein a cow lying area (S) is available under the two limiters, wherein at least at an entrance of the cubicle a mutual distance (L) between the limiters amounts to 105 cm at a maximum, wherein:
each limiter is a substantially horizontal limiter; and/or
each floating limiter extends at a height (H) of at least 50 cm above a lying surface of the cubicle; and/or
at least one of said floating limiters forms part of a substantially horizontally extending U-shaped profile;
wherein a walk-through barrier is provided at a proximal part of the floating limiters, wherein the walk-through barrier is configured to define a central free space, wherein the walk-through barrier comprises two mutually spaced apart, at least partly spheroidal, floating barrier elements, wherein a distance between the two floating barrier elements is in the range of 15-40 cm, wherein each of the two floating barrier elements is at a higher level than a height of the two floating limiters of the cubicle.

18. A stable provided with at least one row of cubicles, which row of cubicles extends along a respective cow walk-through path, wherein at least a number of the cubicles of the row comprise a cubicle according to claim 1.

19. A stable according to claim 18, provided with at least one substantially horizontal U-shaped profile to furnish two substantially horizontal limiters of two neighboring cubicles, wherein each U-shaped profile preferably comprises two straight elongate legs and a horizontal or bent cross leg.
